(19) United States
(12) Patent Application Publication
(10) Pub. No.: US 2011/0244790 A1
(43) Pub. Date: Oct. 6, 2011

(54) RELAY AND METHOD FOR SIGNAL TRANSMISSION THEREOF

(75) Inventors: Byung-Jae KWAK, Seoul (KR); Hyun Kyu Chung, Daejeon (KR); Joon Ho Cho, Pohang-si (KR); Young Yun Kang, Pohang-si (KR)

(73) Assignees: ELECTRONICS AND TELECOMMUNICATIONS RESEARCH INSTITUTE, Daejeon (KR); Postech Academy-Industry Foundation, Pohang-city (KR)

(21) Appl. No.: 13/078,304

(22) Filed: Apr. 1, 2011

(30) Foreign Application Priority Data
Apr. 1, 2010 (KR) 10-2010-0030056
Apr. 1, 2011 (KR) 10-2011-0030059

(51) Int. Cl. H04B 7/14

(52) U.S. Cl. 455/24

(57) ABSTRACT

A method for signal transmission of a relay, includes estimating a first modulation/demodulation channel between a transmitter and the relay and a second modulation/demodulation channel between the relay and a receiver, and an interference channel of the relay, receiving a radio frequency signal from a transmitter, generating a transformation vector using the channel estimate in order to reduce self-interference of the relay under a predetermined level, converting the radio frequency signal using the transformation vector, and transmitting the converted radio frequency signal to the receiver.

### CROSS-REFERENCE TO RELATED APPLICATION

This application claims priority to and the benefit of Korean Patent Application No. 10-2010-0030056 and 10-2011-0030059 filed in the Korean Intellectual Property Office on Apr. 1, 2010 and Apr. 1, 2011, the entire contents of which are incorporated herein by reference.

### BACKGROUND OF THE INVENTION

(a) Field of the Invention

The present invention relates a relay. More particularly, the present invention relates to a relay and a method for signal transmission thereof.

(b) Description of the Related Art

In a cellular system, a relay is installed between a base station and a terminal to improve spectral efficiency and to expand a coverage area. A relay may operate in half-duplex or full-duplex mode. A half-duplex relay transmits and receives signals using two orthogonal channels in a time domain or a frequency domain. Accordingly, a received signal is not interfered by a transmitted signal. On the contrary, a full-duplex relay simultaneously transmits and receives signals. Therefore, the full-duplex relay has an advantage of high spectral efficiency. The full-duplex relay, however, has an interference problem in which a transmitted signal interferes a received signal when the full-duplex relay receives a signal.

A relay may perfectly eliminate an interference signal at a receiving front-end if the channel estimation is perfect. In reality, it is difficult to perfectly eliminate an interference signal due to channel estimation errors. Further, the interference signal may cause non-linear distortion at an amplifier in a receiving front-end of a relay.

Although using a relay designed to perfectly eliminate the interference signal by improving the channel estimation accuracy, the relay transmits a signal only in a direction to a null space of an interference channel. Accordingly, the performance of a relay is deteriorated, and the relay performs very sensitively to channel estimation since too much constraint is imposed on the transmission direction.

### SUMMARY OF THE INVENTION

The present invention has been made in an effort to provide a relay and a method for signal transmission thereof. The present invention has been made in an effort to provide a relay and a method for signal transmission thereof having advantages of minimizing interference of a transmitted signal to a received signal of a receiver when the relay relays a signal of a transmitter to a receiver.

According to an exemplary embodiment, a method for signal transmission of a relay includes estimating a first modulation/demodulation channel between a transmitter and the relay and a second modulation/demodulation channel between the relay and a receiver, and an interference channel of the relay, receiving a radio frequency signal from a transmitter, generating a transformation vector using the estimation result in order to reduce self-interference of the relay under a predetermined level, converting the radio frequency signal using the transformation vector, and transmitting the converted radio frequency signal to the receiver.

According to another exemplary embodiment of the present invention, a relay includes a receiving antenna for receiving a radio frequency signal from a transmitter, a channel estimator for estimating a first modulation/demodulation channel between the transmitter and the relay, a second modulation/demodulation channel between the relay and the receiver, and an interference channel of the relay, a vector generator for generating a transformation vector for reducing self-interference under a predetermined level based on the estimation result of the channel estimator, an interference suppressing unit for converting the radio frequency signal using the transformation vector generated by the vector generator, a transmitting antenna for transmitting the converted radio frequency signal to the receiver.

According to still another exemplary embodiment of the present invention, a method for generating a transformation vector in a relay, includes estimating a first modulation/demodulation channel between a transmitter and the relay, a second modulation/demodulation channel between the relay and a receiver, and an interference channel of the relay; and generating a transformation vector to maximize an mutual information between the transmitter and the receiver using the estimation result.

### BRIEF DESCRIPTION OF THE DRAWINGS

FIG. 1 is a diagram that illustrates a wireless communication system according to an exemplary embodiment of the present invention.

FIG. 2 is a diagram that illustrates a channel of a wireless communication system according to an exemplary embodiment of the present invention.

FIG. 3 is a block diagram illustrating a relay 300 according to an exemplary embodiment of the present invention.

FIG. 4 is a block diagram that illustrates a signal converter 340 in a relay 300.

FIG. 5 is a flowchart that illustrates a method for signal transmission of a relay 300 according to an exemplary embodiment of the present invention.

FIG. 6 is a diagram that illustrates a signal model for generating a transformation vector in a relay 300 according to an exemplary embodiment of the present invention.

FIG. 7 to FIG. 9 illustrate an application example of a transformation vector g generated according to an exemplary embodiment of the present invention.

FIG. 10 illustrates another application example of a transformation vector g generated according to an exemplary embodiment of the present invention.

FIG. 11 is a graph that illustrates a channel capacity between a base station and a terminal according to a signal to cancelled interference ratio (SCIR) that means the power ratio between a suppressed interference signal and a desired signal from a base station according to an exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification, in addition, unless explicitly described to the contrary, the word “comprise” and variations such as “comprises” or “comprising” will be understood to imply the inclusion of stated elements but not the exclusion of any other elements.

In the specification, a terminal may be referred to as a mobile station (MS), a mobile terminal (MT), a subscriber station (SS), a portable subscriber station (PSS), user equipment (UE), and access terminal (AT). Further, a terminal may include entire or a part of functions of a terminal, a mobile station, a mobile terminal, a subscriber station, a portable subscriber station, user equipment, and an access terminal.

In the specification, a base station (BS) may be referred as an access point (AP), a radio access station (RAS), a node B, an evolved Node B (eNodeB), a base transceiver station (BTS), and a mobile multihop relay base station (MMR-BS). The base station may include entire or a part of functions of an access point, a radio access station, a node B, an evolved Node B, a base transceiver station, and a mobile multihop relay base station.

Hereinafter, a relay (it may be also referred as “repeater”) and a method for signal transmission thereof according to an exemplary embodiment of the present invention will be described in detail with reference to the accompanying drawings.

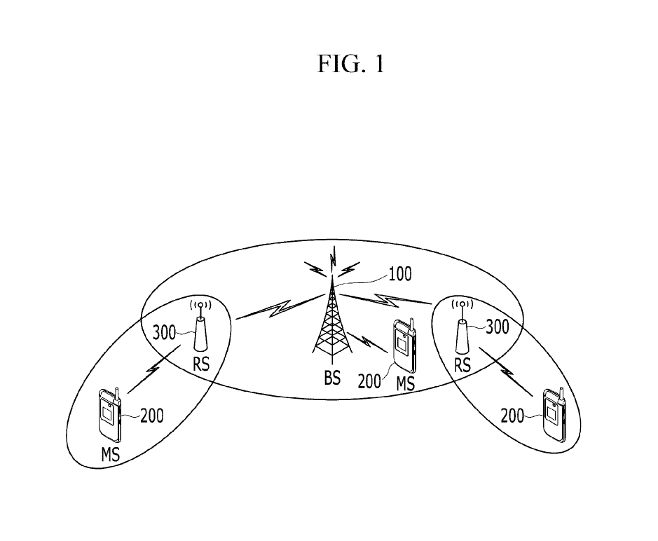

FIG. 1 is a diagram that illustrates a wireless communication system according to an exemplary embodiment of the present invention.

Referring to FIG. 1, a wireless communication system includes a base station 100, a terminal 200, and a relay 300. The relay 300 improves spectral efficiency and expands a coverage area. The relay 300 is installed between the terminal 200 and the base station 100. The terminal 200 in the coverage area of the base station 100 directly communicates with the base station 100. The terminal 200 outside the coverage area of the base station 100 communicates with the base station 100 through the relay 300. Although the terminal 200 is located in the coverage area of the base station 100, the terminal 200 may communicate with the base station 100 through the relay 300 in order improve a transmission rate according to diversity effect.

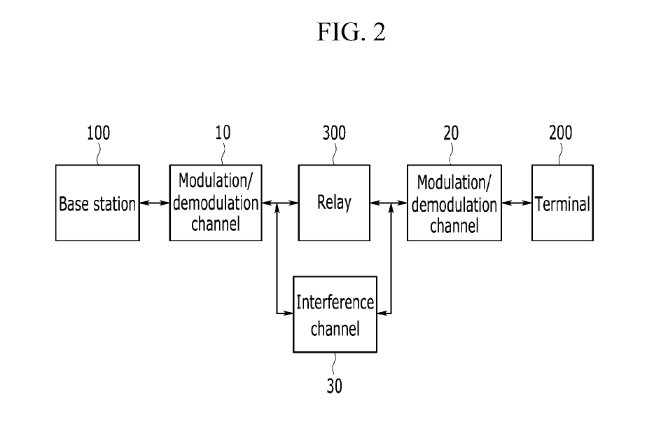

FIG. 2 is a diagram that illustrates a channel in a wireless communication system according to an exemplary embodiment of the present invention.

Referring to FIG. 2, the relay 300 receives a radio frequency signal transmitted from the base station 100 through a modulation/demodulation channel 10, modulates and transmits the modulated signal to the terminal 200 through the modulation/demodulation channel 20. The relay 300 receives the radio frequency signal from the terminal 200 through the modulation/demodulation channel 20, modulates the received signal, and transmits the modulated signal to the base station 100 through the modulation/demodulation channel 10.

It is assumed that the relay 300 operates in full-duplex. The full-duplex means that signal is simultaneously transmitted and received in the same frequency band. Accordingly, a signal transmitted from the relay 300 may be received at the relay 300 again through the interference channel 30. That is, the transmitted signal may interfere and distort the received signal in the full-duplex relay 300. It is called self-interference.

The relay 300 according to an exemplary embodiment of the present invention sets a transmitted signal in order to control an interference signal passing through the interference channel 30 to be lower than a predetermined level.

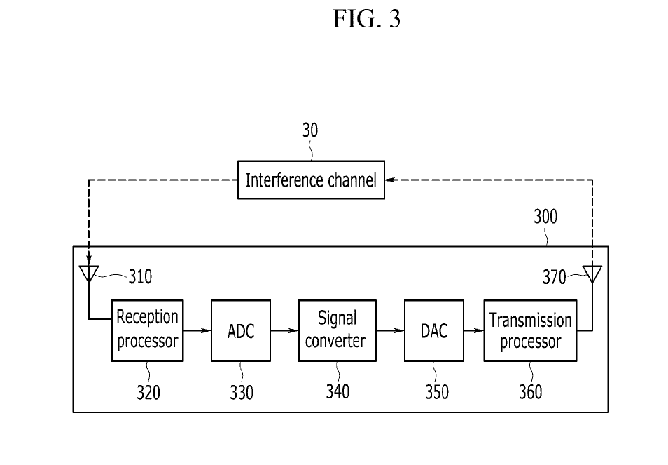

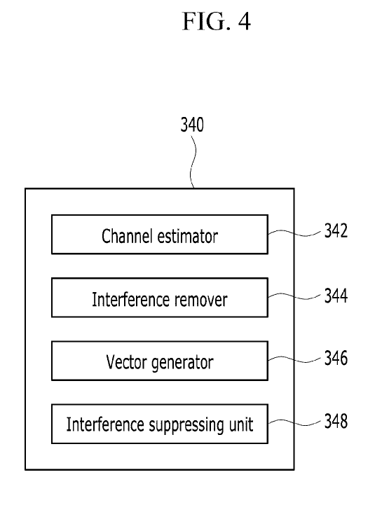

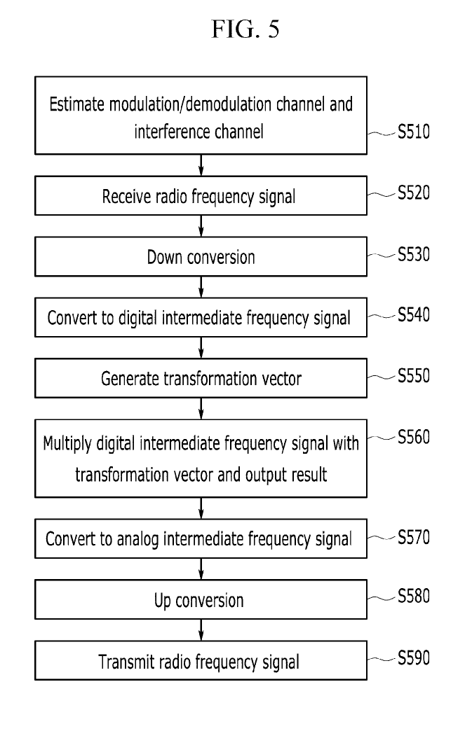

FIG. 3 is a block diagram that illustrates a relay 300 according to an exemplary embodiment of the present invention. FIG. 4 is a block diagram that illustrates a signal converter 340 in the relay 300. FIG. 5 is a flowchart that illustrates a method for signal transmission of the relay according to an exemplary embodiment of the present invention.

Referring to FIG. 3 and FIG. 4, the relay 300 includes a receiving antenna 310, a reception processor 320, an analog-to-digital converter (ADC) 330, a signal converter 340, a digital-to-analog converter (DAC) 350, a transmission processor 360, and a transmitting antenna 370.

The receiving antenna 310 receives a radio frequency signal from the base station 100 or the terminal 200.

The reception processor 320 amplifies the radio frequency signal received through the receiving antenna 310, filters the amplified signal, and down-converts the filtered signal to an intermediate frequency signal.

The ADC 330 converts the intermediate signal from the reception processor 320 to a digital intermediate frequency signal by sampling the intermediate signal from the reception processor 320.

The signal converter 340 includes a channel estimator 342, an interference remover 344, a vector generator 346, and an interference suppressing unit 348. The channel estimator 342 estimates the modulation/demodulation channel 10 and 20 and the interference channel 30 using a pilot signal. The interference remover 344 eliminates the residual self-interference signal under a predetermined level. Here, the residual self-interference signal is received through the interference channel 30. The vector generator 346 generates a transformation vector using the estimation result of the modulation/demodulation channel 10 and 20 and interference channel 30 in order to suppress the interference signal and optimize performance of the relay 300. The interference suppressing unit 348 multiplies the digital intermediate frequency signal from the ADC 330 with the transformation vector from the vector generator 346 and transfers the multiplication result to the DAC 350.

The interference channel 30 is a channel formed from the DAC 350 to the receiving antenna 310. That is, the interference channel 30 includes the DAC 350, the transmission processor 360, the transmitting antenna 370, and the receiving antenna 310.

The modulation/demodulation channel 10 is a channel including a radio channel formed between a transmission processor (not shown) of the base station 100 and the reception processor 320 of the relay 300 and a radio channel formed between the base station a 100 and the relay 300. The modulation/demodulation channel 20 is a channel including a radio channel formed between the transmission processor 360 of the relay 300 and a radio channel between the relay 300 and the terminal 200.

The radio channel means a channel including transmitting/receiving antennas and a propagation channel. The propagation channel means physical phenomenon, such as reflection and refraction occurred while an electromagnetic wave propagates.

The DAC 350 converts the digital intermediate frequency signal, which is converted by the signal converter 340, to an analog intermediate frequency signal.

The transmission processor 360 up-converts the analog intermediate frequency signal from the DAC 350 to the radio frequency signal, and amplifies and filters the radio frequency signal.

The transmitting antenna 370 transmits the up-converted radio frequency signal.

Referring to FIG. 3 to FIG. 5, the signal converter 340 of the relay 300 estimates the modulation/demodulation channel 10 and 20 and the interference channel 30 using a pilot signal at step S510. The signal converter 340 of the relay 300 can detect a vector of the interference channel 30 and a channel matrix of the modulation/demodulation channel 10 and 20 through channel estimation.

When the receiving antenna 310 of the relay 300 receives a radio frequency signal from a transmitter at step S520, the reception processor 320 amplifies the radio frequency signal, filters the amplified radio frequency signal, down-converts the filtered signal into an intermediate frequency signal at step S530, and the ADC 330 converts the intermediate frequency signal to a digital intermediate frequency signal at step S540. In case of downlink transmission, the transmitter is a base station 100 and a receiver is a terminal 200. On the contrary, in case of uplink transmission, the transmitter is the terminal 200, and the receiver is the base station 100.

At step S550, the signal converter 340 generates a transformation vector using the channel estimate estimated in the step S510. The generation of the transformation vector g will be described in later.

At step S560, the signal converter 340 of the relay 300 multiplies the transformation vector with the digital intermediate frequency signal in the step S540.

At step S570, the DAC 350 converts the digital intermediate frequency signal of the step S560 to an analog intermediate frequency signal, the transmitter 360 up-converts the analog intermediate frequency signal to a radio frequency signal and filters the radio frequency signal at step S580. The transmitting antenna 370 transmits the up-converted radio frequency signal to the receiver at step S590.

As described above, the radio frequency signal transmitted through the transmitting antenna 370 is a signal converted by the transformation vector generated from the signal converter 340. Accordingly, interference is suppressed under a predetermined level while the radio frequency signal transmitted through the transmitting antenna 370 passes through the interference channel 30.

Hereinafter, a method of generating a transformation vector by a relay 300 according to an exemplary embodiment of the present invention will be described in detail.

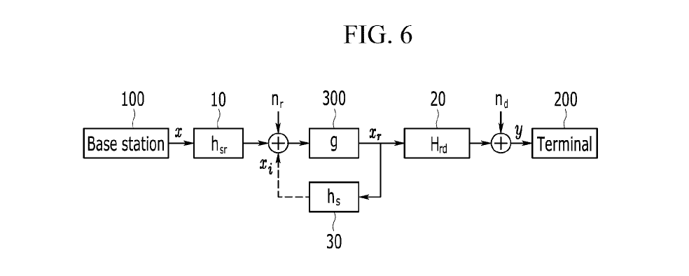

FIG. 6 is a diagram that illustrates a signal model for generating a transformation vector in a relay according to an exemplary embodiment of the present invention. For example, FIG. 6 illustrates the relay 300 transmits a signal from a base station 100 to a terminal 200 through downlink.

Referring to FIG. 6, Equation 1 shows a signal γ received at the terminal 200 when the relay 300 eliminates a residual interference signal xᵢ passed through the interference channel hₛ by performing a digital signal process.

y[t]=H_{rd}ghₛᵣx[t−τ]+H_{rd}gnₜ[t−τ]+n_{d}[t] (Equation 1)

In Equation 1, y denotes a signal vector of a received signal of the terminal 200, and x denotes a signal transmitted from the base station 100. hₛᵣ denotes a modulation/demodulation channel 10 between the base station 100 and the relay 300, and H_{rd} denotes a channel matrix of a modulation/demodulation channel 20 between the relay 300 and the terminal 200. nᵣ denotes noise added at a receiving end of the relay 300, and n_{d} denotes a noise vector added at a receiving end of the terminal 100. g is a transformation vector generated by the relay 300, and τ is a processing delay in the relay 300.

The signal converter 340 of the relay 300 according to an exemplary embodiment of the present invention generates a transformation vector in order to optimize the performance of the relay 300 and suppress the interference signal simultaneously.

For this purpose, the transformation vector g may be set up to maximize a mutual information between the base station 100 and the terminal 200 or a signal to interference plus noise ratio (SINR) in the terminal 200.

Further, the transformation vector g may be set up to minimize mean square error (MSE) between a transmitted signal of the base station 100 and a received signal of the terminal 200 or a bit error rate (BER) between the transmitted signal of the base station 100 and the received signal of the terminal 200.

Hereinafter, a method for generating a transformation vector g to maximize the mutual information between the base station 100 and the terminal 200 will be described in detail.

At first, the signal converter 340 of the relay 300 calculates a channel capacity using Equation 2.

$${maximize}_{g} I ( x ; y ) \\ subject to 𝔼 \{ {‖ {x}_{r} ‖}^{2} \} \leq {\tilde{P}}_{r} \\ 𝔼 \{ {\vert {x}_{i} \vert}^{2} \} \leq {\tilde{P}}_{i} \qquad ( Equation 2 )$$

I(x; y) denotes a mutual information between a transmitted signal x of the base station 100 and the received signal vector y of the terminal 200. E{·} denotes an expected value, xᵣ is a transmitted signal vector of the relay 300, and xᵢ is an interference signal passing through the interference channel hₛ. \tilde{P}ᵣ denotes the maximum output power of the relay 300 and \tilde{P}ᵢ is the maximum power of an allowable interference signal in a receiving antenna of the relay 300. The mutual information, which is an objective function of the Equation 2, can be expressed as Equation 3.

I(x:y)=log₂[1+Pₛ|hₛᵣ|² [symbol] (σᵣ²H_{rd}g [symbol] +σ_{d}²I_{M})⁻¹H_{rd}g] (Equation 3)

In Equation 3, Pₛ is transmission power of the base station 100, σᵣ² is noise variance of the relay 300, and σ_{d}² is noise variance of the terminal 200. hₛᵣ denotes a modulation/demodulation channel 10 between the base station 100 and the relay 300, and H_{rd} denotes a channel matrix of a modulation/demodulation channel 20 between the relay 300 and the terminal 200, and g denotes a transformation vector of the relay 300.

Further, the maximum output power \tilde{P}ᵣ of Equation 2 may be expressed based on Equation 4 or Equation 5. Equation 4 means average power constraint and Equation 5 denotes per-antenna power constraint.

(Pₛ|hₛᵣ|²+σᵣ²)∥g∥²≦\tilde{P}ᵣ (Equation 4)

(Pₛ|hₛᵣ|²+σᵣ²)|gᵢ|²≦\tilde{P}ᵣᵢ (Equation 5)

In Equation 5, gᵢ denotes the i^{th} component of the transformation vector g, and \tilde{P}ᵣᵢ denotes the maximum power of the i^{th} transmitting antenna of the relay 300.

Meanwhile, the mutual information of Equation 3 may be modified to Equation 6 using Sherman-Morrison Equation.

$$\begin{matrix}I ( x ; y ) = {log}_{2} [ 1 + {P}_{s} {\vert {h}_{sr} \vert}^{2} {g}^{ℋ} {H}_{rd}^{ℋ} ( \begin{matrix}\frac{1}{{σ}_{d}^{2}} {I}_{M} - \\ \frac{\frac{{σ}_{r}^{2}}{{σ}_{d}^{4}} {H}_{rd} {gg}^{ℋ} {H}_{rd}^{ℋ}}{\begin{matrix}1 + \\ \frac{{σ}_{r}^{2}}{{σ}_{d}^{2}} {g}^{ℋ} {H}_{rd}^{ℋ} {H}_{rd} g\end{matrix}}\end{matrix} ) {H}_{rd} g ] \\ = {log}_{2} ( 1 + {P}_{s} {\vert {h}_{sr} \vert}^{2} \frac{{g}^{ℋ} {H}_{rd}^{ℋ} {H}_{rd} g}{{σ}_{r}^{2} {g}^{ℋ} {H}_{rd}^{ℋ} {H}_{rd} g + {σ}_{d}^{2}} )\end{matrix} \qquad ( Equation 6 )$$

Since finding a transformation vector g that maximizes the mutual information is equivalent to finding transformation vector g that maximizes [symbol] H_{rd}g, it may be expressed as an optimization problem given by Equation 7.

$${maximize}_{g} {g}^{ℋ} {H}_{rd}^{ℋ} {H}_{rd} g \\ subject to {‖ g ‖}^{2} \leq {P}_{r} \\ {\vert {h}_{s}^{ℋ} g \vert}^{2} \leq {\overline{P}}_{i} \\ {P}_{r} {=}^{Δ} {\tilde{P}}_{r} / ( {P}_{s} {\vert {h}_{sr} \vert}^{2} + {σ}_{r}^{2} ) \\ {\overline{P}}_{i} {=}^{Δ} {\tilde{P}}_{i} / ( {P}_{s} {\vert {h}_{sr} \vert}^{2} + {σ}_{r}^{2} ) \qquad ( Equation 7 )$$

In Equation 7, g is a transformation vector, H_{rd} is a channel matrix of a modulation/demodulation channel 20 between the relay 300 and the terminal 200, and hₛ is an interference channel vector. Pᵣ is the maximum power of a transformation vector, \tilde{P}ᵢ is a maximum power of inner product between the interference channel vector and the transformation vector.

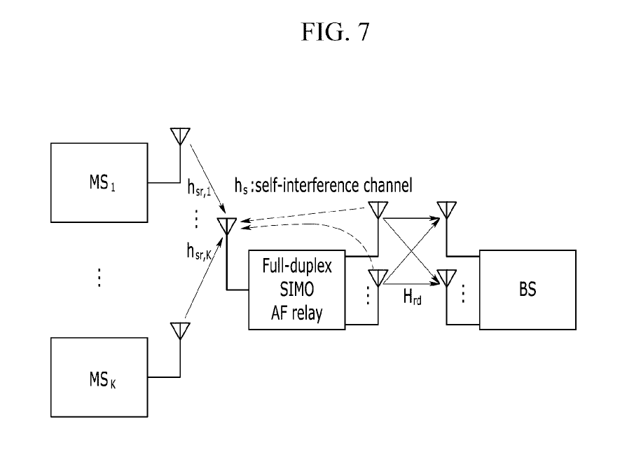

FIG. 7 to FIG. 9 illustrate a transformation vector g generated according to an exemplary embodiment of the present invention. For example, direct link is not formed between the terminal 200 and the base station 100.

Referring to FIG. 7, the optimization of Equation 7 can be applied when signal-to-noise ratio (SNR) is an objective function in a receiving end of the base station 100 and a plurality of terminals transmit signals through uplink.

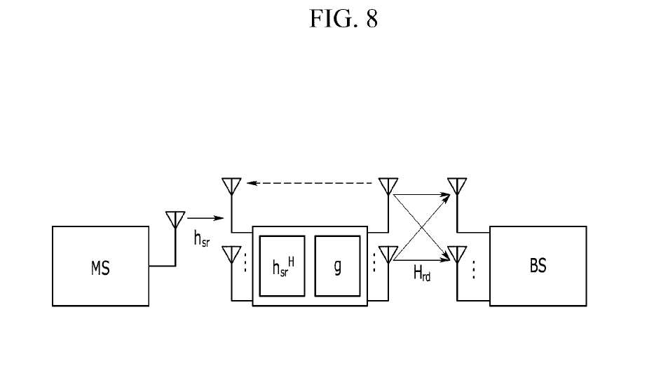

Referring to FIG. 8, the relay 300 performs receiver beam-forming with a fixed gain to a shadow area although a plurality of receiving antennas are used. Ever for this case, the optimization of Equation 7 can be applied thereto.

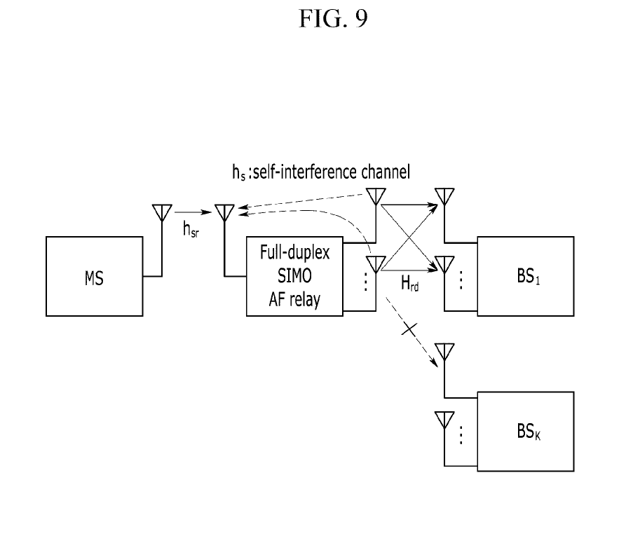

Referring to FIG. 9, the optimization of Equation 7 can be applied through projection on a simple null space when the relay 300 tries to transmit a signal to a target base station while not interfering adjacent base stations.

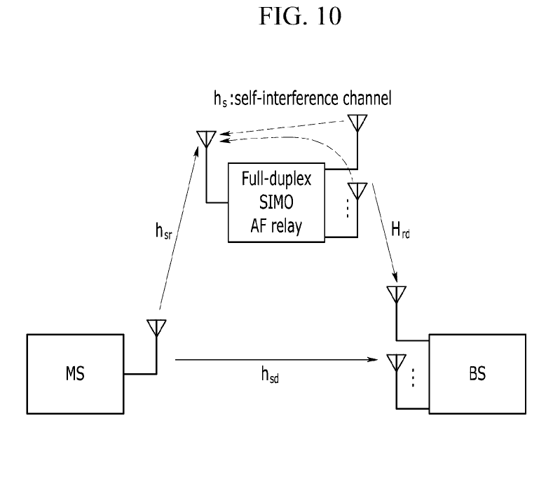

FIG. 10 illustrates another application example of a transformation vector g generated according to an exemplary embodiment of the present invention. For example, direct link is formed between the terminal 200 and the base station 100.

Referring to FIG. 10, the relay 300 artificially controls a delay time in the relay 300. Through such artificial control, the relays 300 separates a signal received from the relay 300 from a signal transmitted from the terminal 200. Further, the relay 300 performs modeling noise in the base station 100 to colored noise included in signals from the direct link and performs noise whitening. Therefore, the optimization of Equation 7 can be applied.

In order to simplify an interference constraint in the optimization of Equation 7, a variable g is converted to ƒ through unitary transformation of Equation 8.

g=Sƒ (Equation 8)

In Equation 8, a unitary matrix S can be expressed as Equation 9. That is, the first column of the unitary matrix S can be obtained by normalizing the interference channel vector hₛ. The other columns can be calculated through a Gram-Schmidt orthogonalization method.

$$S = [ \begin{matrix}{s}_{1} & {s}_{2} & … & {s}_{N}\end{matrix} ] , {s}_{1} = \frac{{h}_{s}}{‖ {h}_{s} ‖} \qquad ( Equation 9 )$$

The modified optimization problem can be expressed as Equation 10. The interference constraint is expressed as only for the first component of vector ƒ, which is an optimization variable of the interference constraint.

$${maximize}_{f} {f}^{ℋ} A f \\ subject to {‖ f ‖}^{2} \leq {P}_{r} \\ {\vert {f}_{1} \vert}^{2} \leq {P}_{i} \\ A {=}^{Δ} {S}^{ℋ} {H}_{rd}^{ℋ} {H}_{rd} S \\ {P}_{i} {=}^{Δ} {\overline{P}}_{i} / {‖ {h}_{s} ‖}^{2} \qquad ( Equation 10 )$$

In Equation 10, ƒ₁ denotes the first component of ƒ. In order to obtain an optimal solution of this problem, Karush-Kuhn-Tucker (KKT) is calculated, which is a necessary condition of the optimal solution. Equation 11 shows a Lagrangian function.

[symbol]

(ƒ, λ₁, λ₂, ν)=− [symbol] Aƒ+λ₁(|ƒ₁|²−Pᵢ)−λ₂(|ƒ₁|²)+ν(∥ƒ∥²−Pᵣ) (Equation 11)

The KKT solution must satisfy conditions of Equation 12.

$${‖ {f}^{*} ‖}^{2} = {P}_{r} \\ - {\vert {f}_{1}^{*} \vert}^{2} \leq 0 \\ {\vert {f}_{1}^{*} \vert}^{2} \leq {P}_{i} \\ {λ}_{1}^{*} \geq 0 \\ {λ}_{2}^{*} \geq 0 \\ {λ}_{1}^{*} ( {\vert {f}_{1}^{*} \vert}^{2} - {P}_{i} ) = 0 \\ {λ}_{2}^{*} {\vert {f}_{1}^{*} \vert}^{2} = 0 \\ ( A - {v}^{*} {I}_{N} ) {f}^{*} = ( {λ}_{1}^{*} - {λ}_{2}^{*} ) [ \begin{matrix}{f}_{1}^{*} \\ 0\end{matrix} ] \qquad ( Equation 12 )$$

In the KKT condition of Equation 12, a KKT solution may be divided into two cases according to λ₁* and λ₂*.

first case: λ₁*=0, λ₂*=0

second case: λ₁*=0, λ₂* >0

In the first case, the optimal value ƒ* is an eigenvector corresponding to the maximum eigenvalue of the matrix A as shown in Equation 13.

ƒf*=\sqrt{Pᵣ}νₘₐₓ (Equation 13)

In Equation 13, νₘₐₓ becomes an eigenvector corresponding to the maximum eigenvalue among eigenvectors of the matrix A that satisfies 0≦|ƒ₁*|²≦Pᵢ.

In the second case, ƒ is divided into a component of an interference channel vector direction and components of the other directions as shown in Equation 14.

$$f = [ \begin{matrix}{f}_{1} \\ {f}_{2}\end{matrix} ] and A = [ \begin{matrix}{a}_{11} & {a}_{21}^{ℋ} \\ {a}_{21} & {A}_{22}\end{matrix} ] \qquad ( Equation 14 )$$

In this case, the KKT conditions may be simplified into Equation 15.

|ƒ₁*|²=Pᵢ

∥ƒ₂*∥²=Pᵣ−Pᵢ

[symbol]

ƒ₂*=(ν*+λ₁*−α₁₁)ƒ₁*

ƒ₂*=−ƒ₁*(A₂₂−ν*I_{N-1})†α₂₁ (Equation 15)

In the KKT conditions of Equation 15, ν* can be calculated from Equation 16.

$${P}_{i} \cdot {\sum }_{k = 1 , {u}_{k} \neq {v}^{*}}^{N - 1} {\vert \frac{{υ}_{k}^{ℋ} {a}_{21}}{{μ}_{k} - {v}^{*}} \vert}^{2} = {P}_{r} - {P}_{i} \qquad ( Equation 16 )$$

In Equation 16, μᵢ is an eigenvector of A₂₂ , and νᵢ is a corresponding eigenvector. ƒ vector is calculated from candidates of the optimal solutions, and applies to the objective function. The vector with the maximum value becomes the optimal solution ƒ*. Accordingly, Equation 17 shows the optimal solution of the second case.

$$\begin{matrix}{f}^{*} = [ \begin{matrix}1 \\ - {( {A}_{22} - {v}^{*} {I}_{N - 1} )}^{†} {a}_{21}\end{matrix} ] {f}_{1}^{*} \\ = [ \begin{matrix}1 \\ - {( {A}_{22} - {v}^{*} {I}_{{N}^{′} - 1} )}^{†} {a}_{21}\end{matrix} ] \sqrt{{P}_{i}} {e}^{j θ}\end{matrix} \qquad ( Equation 17 )$$

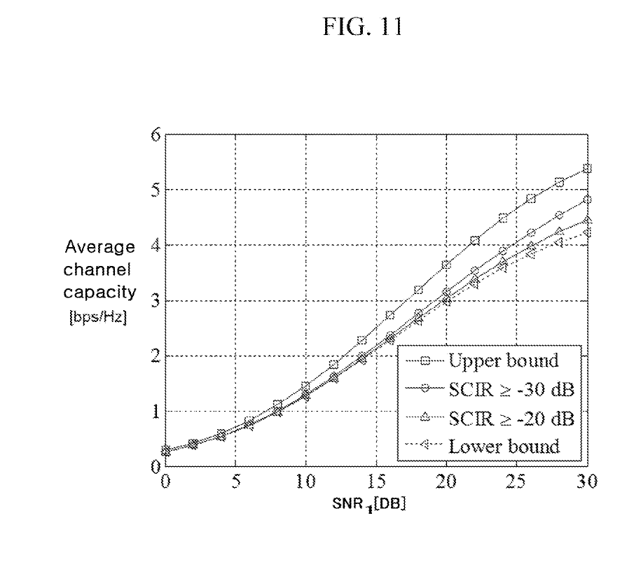

FIG. 11 is a graph that illustrates a channel capacity between a base station and a terminal according to a signal to cancelled interference ratio (SCIR) that means the power ratio between a suppressed interference signal and a desired signal from a base station according to an exemplary embodiment of the present invention.

In FIG. 11, it is assumed that the modulation/demodulation channel 10 and 20 and the interference channel 30 are perfectly known to the relay 300. Equation 18 shows the SCIR.

$$SCIR [ dB ] = 10 {log}_{10} ( \frac{{P}_{s} {\vert {h}_{sr} \vert}^{2}}{{\tilde{P}}_{i}} ) \qquad ( Equation 18 )$$

In Equation 18, SNR₂ is fixed to about 10 dB for uplink transmission. SNR₂ is a signal to noise ratio between the relay 300 and the base station 100. It is assumed that a channel is zero mean complex Gaussian. It is also assumed that a power of the interference channel 30 is about 50 dB greater than the modulation/demodulation channels 10 and 20. Further, a SNR₁ is changed and an average channel capacity is calculated under an assumption that the relay 300 includes two transmitting antennas and the base station 100 includes two receiving antennas. The SNR₁ is a signal to noise ratio between the terminal 200 and the relay 300.

As described above, the graph of FIG. 11 shows that the performance of the relay 300 according to the exemplary embodiment of the present invention is improved compared to a lower bound scheme which perfectly eliminates interference. That is, the performance is improved if the transformation vector is optimized based on a SCIR constraint to suppress the self-interference signal received at the receiving antenna 310 as much as not occurring non-linear distortion in the reception processor 320.

According to an exemplary embodiment of the present invention, it is possible to control a transmitted signal not to interfere a received signal in the full-duplex relay. Accordingly, the performance of the relay can be improved without excessive constraint to a transmission direction of a transmitted signal of the relay. Accordingly, a relay having a single receiving antenna and multiple transmitting antennas can transfer a signal while minimizing interference as well as a relay having a single receiving antenna and a single transmitting antenna.

The apparatus and method according to an exemplary embodiment of the present invention described above can be realized as a program performing functions corresponding to configuration elements of the apparatus and method or as a computer readable recording medium storing the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for signal transmission of a relay, comprising:
estimating a first modulation/demodulation channel between a transmitter and the relay and a second modulation/demodulation channel between the relay and a receiver, and an interference channel of the relay;
receiving a radio frequency signal from a transmitter;
generating a transformation vector using the estimation result in order to reduce self-interference of the relay under a predetermined level;
converting the radio frequency signal using the transformation vector; and
transmitting the converted radio frequency signal to the receiver.

2. The method of claim 1, wherein the relay operates in full-duplex where signals are transmitted and received simultaneously.

3. The method of claim 1, wherein in the estimating, a pilot signal is used.

4. The method of claim 1, wherein the transformation vector is generated based on an objective function for optimizing performance of the relay and a power constraint.

5. The method of claim 4, wherein the power constraint is one of average power constraint and per antenna power constraint.

6. The method of claim 4, wherein the objective function is at least one of mutual information between the transmitter and the receiver, a signal to interference and noise ratio (SINR) of the receiver, a mean square error (MSE) between the transmitter and the receiver, and a bit error rate between the transmitter and the receiver.

7. The method of claim 6, wherein the transformation vector is generated to maximize the mutual information when the objective function is the mutual information,
the transformation vector is generated to maximize the signal to interference plus noise ratio when the objective function is the signal to interference plus noise ratio,
the transformation vector is generated to minimize the mean square error when the objective function is the mean square error,
the transformation vector is generate to minimize the bit error rate when the objective function is the bit error rate.

8. The method of claim 7, wherein the transformation vector is generated to satisfy
$${maximize}_{g} {g}^{ℋ} {H}_{rd}^{ℋ} {H}_{rd} g$$
$$subject to {‖ g ‖}^{2} \leq {P}_{r}$$
$${\vert {h}_{s}^{ℋ} g \vert}^{2} \leq {\overline{P}}_{i}$$
when the objective function is the mutual information.
where, g is a transformation vector, H_{rd} is a channel matrix of a modulation/demodulation channel between the relay and the receiver, hₛ is an interference channel vector, Pᵣ is a maximum power of the transformation vector, and P̅ᵢ is a size of a maximum power of inner product between the interference channel vector and the transformation vector.

9. A relay comprising:
a receiving antenna for receiving a radio frequency signal from a transmitter;
a channel estimator for estimating a first modulation/demodulation channel between the transmitter and the relay, a second modulation/demodulation channel between the relay and the receiver, and an interference channel of the relay;
a vector generator for generating a transformation vector for reducing self-interference under a predetermined level based on the channel estimate of the channel estimator;
an interference suppressing unit for converting the radio frequency signal using the transformation vector generated by the vector generator; and
a transmitting antenna for transmitting the converted radio frequency signal to the receiver.

10. The relay of claim 9, wherein the relay operates in full-duplex that performs transmitting and receiving signals simultaneously.

11. The relay of claim 9, further comprising:
an interference remover for eliminating residual self-interference signal which is an interference signal lowered under a predetermined level through the interference channel.

12. The relay of claim 9, wherein the transformation vector is generated based on an objective function for optimizing performance of the relay and power constraints.

13. The relay of claim 12, wherein the power constraint is one of an average power constraint and a per-antenna per power constraint.

14. The relay of claim 12, wherein the objective function is at least one of a mutual information between the transmitter and the receiver, a signal to interference plus noise ratio (SINR) of the receiver, an mean square error (MSE) between the transmitter and the receiver, and a bit error rate (BER) between the transmitter and the receiver.

15. The relay of claim 9, further comprising:
a reception processor for down-converting the radio frequency signal received through the receiving antenna to an intermediate frequency signal;
an analog-digital converter for converting the intermediate frequency signal to a digital signal;
a digital-analog converter for converting the converted radio frequency signal to an analog signal; and
a transmitter for up-converting the analog signal to the radio frequency signal.

16. A method for generating a transformation vector in a relay, the method comprising:
estimating a first modulation/demodulation channel between a transmitter and the relay, a second modulation/demodulation channel between the relay and a receiver, and an interference channel of the relay; and
generating a transformation vector to maximize a mutual information between the transmitter and the receiver using the channel estimate.

17. The method of claim 16, wherein:
the transformation vector is generated to satisfy
$${maximize}_{g} {g}^{ℋ} {H}_{rd}^{ℋ} {H}_{rd} g$$
$$subject to {‖ g ‖}^{2} \leq {P}_{r}$$
$${\vert {h}_{s}^{ℋ} g \vert}^{2} \leq {\overline{P}}_{i} ,$$
where, g is a transformation vector, H_{rd} is a channel matrix of a modulation/demodulation channel between a relay and a receiver, hₛ is an interference channel vector, Pᵣ is an maximum power of a transformation vector, and P̅ᵢ is a maximum power of inner product between the interference channel vector and the transformation vector.

18. The method of claim 17, wherein the maximum output power denotes one of an average power constraint and a per-antenna per power constraint.
